(19) United States
(12) Patent Application Publication
(10) Pub. No.: US 2008/0031020 A1
(43) Pub. Date: Feb. 7, 2008

(54) Circuit and method for detecting electric current

(75) Inventor: Seung-yo Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/652,067

(22) Filed: Jan. 11, 2007

(30) Foreign Application Priority Data
Aug. 2, 2006 (KR) 10-2006-0073072

(51) Int. Cl. H02M 1/12

(52) U.S. Cl. 363/40

(57) ABSTRACT

Provided are a circuit and method for detecting an electric current which are capable of controlling the amount of electric current by detecting a load current of a current source using a switching type converter when controlling the load current of the current source which requires a high current, and compensating electric current flowing in the load. Accordingly, damage to the overall circuit is reduced compared to a related art method of detecting current using a resistor when detecting the load current of the current source with a high current, the amount of heat generated is reduced compared to such related art method, the overall efficiency of the current source device is enhanced and manufacturing costs are decreased.

### CROSS-REFERENCE TO RELATED APPLICATIONS

This application claims priority from Korean Patent Application No. 10-2006-0073072, filed in the Korean Intellectual Property Office on Aug. 2, 2006, the entire disclosure of which is incorporated herein by reference.

### BACKGROUND OF THE INVENTION

1. Field of the Invention

The present invention relates to a circuit and method for detecting an electric current. More particularly, the present invention relates to a circuit and method for detecting an electric current which are capable of controlling the amount of electric current by detecting without loss the load current of a current source using a switching type converter when controlling the load current of the current source which requires a high current, and compensating electric current flowing in loads.

2. Description of the Related Art

FIG. 1 is a schematic circuit diagram illustrating the structure of a related art switching type current-controlled converter.

The conventional switching type current-controlled converter is a buck type direct current (DC) converter, wherein an inductor-capacitor (LC) filter and a freewheeling diode D2 are connected to one side of a switching element Q1 typically implemented by a Metal oxide semiconductor field effect transistor (MOSFET), and a load such as a light emitting diode D3 is connected in parallel to a capacitor C2 of the LC filter. In the LC filter, an inductor L is connected in series to the switching element Q1 and the capacitor C2 is connected in parallel to the inductor L.

Additionally, a differential amplifier 130 is connected to both sides of a resistor R in order to detect a current of the load-bearing light emitting diode D3, and a current error detector 140 is connected to an output end of the differential amplifier 130 in order to detect an error signal of an output current for a reference current Iref.

If the current error signal from the current error detector 140 is transmitted to a compensator 110, the compensator 110 drives the switching element Q1 through a gate driver 120 according to the current error signal so that the current flowing in the load-bearing light emitting diode D3 is controlled.

The related art switching type current-controlled converter with a current source having a topology such as the aforementioned buck converter includes a current controller to supply current necessary for the load. Additionally, in order to control the load current, a switch of the current source (the buck converter) has to be adjusted and a current detector for current feedback of the current controller is needed. Accordingly, the current detector uses a resistor for detecting a current or a hall sensor to detect a load current. Consequently, the current is detected using the resistor or the hall sensor, and after the current is compared with the reference current, the difference is compensated through the controller (compensator).

Such method of detecting the current using the resistor has an associated drawback in that if a high current flows in the load, the circuit is over-heated. As a result, there is a substantial cost associated with cooling the circuit. In addition, if a hall sensor is used, the bulk and complexity of the device increases and the manufacturing costs increase as a consequence.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention addresses the aforementioned associated drawbacks and provides the following features described below. An aspect of the present invention is to provide a circuit and method for detecting an electric current which are capable of controlling the amount of electric current by detecting without loss a load current of a current source using a switching type converter when controlling the load current of the current source which requires a high current, and compensating electric current flowing in loads.

Exemplary embodiments of the present invention provide a device for detecting an electric current including an RC circuit which detects an electric current of a first inductor connected in series to a load; a LR circuit which detects an electric current of a second capacitor connected in parallel to the load; and a subtractor which calculates a difference current which is the difference between the current detected in the RC circuit and the current detected in the LR circuit.

The electric current of the first inductor is an electric current flowing in the first inductor and an internal resistor of the first inductor.

In the RC circuit, a first resistor and a first capacitor which are connected to each other in series are connected to the first inductor in parallel, and both ends of the first capacitor are connected to a first differential amplifier to detect the electric current of the first inductor.

A voltage between both ends of the first capacitor is calculated using V_{C1}(S)=Rₑₛᵣ₁I₁(S), where Rₑₛᵣ₁ is the internal resistor of the first inductor and I_{L1} is the electric current of the first inductor.

The electric current of the second capacitor flows in the second capacitor and an internal resistor of the second capacitor.

In the LR circuit, a second resistor and a second inductor which are connected to each other in series are connected in parallel to the second capacitor, and both ends of the second inductor are connected to a second differential amplifier to detect the electric current of the second capacitor.

A voltage between both ends of the second inductor is calculated using V_{L2}(S)=Rₑₛᵣ₂I_{C2}, where Rₑₛᵣ₂ is the internal resistor of the second capacitor and I_{C2} is the electric current of the second capacitor.

The device further includes a current error detector which generates an error signal based on the difference current calculated by the subtractor and a reference current; a compensator which outputs a compensation signal to compensate the current flowing at the level of the error output from the current error detector; and a switching part which controls the current flowing in the load according to the compensation signal output from the compensator.

In the switching part, a first MOSFET is connected in series to the load and the first inductor, and a second MOSFET, which is grounded, is connected in parallel to the first MOSFET. The switching part further comprises a gate driver which drives the first MOSFET and the second MOSFET according to the transmitted compensation signal.

The first MOSFET and the second MOSFET are each embedded with a body diode which is connected inversely in parallel.

Further, another aspect of the present invention is to provide a method for detecting an electric current, the method including: detecting an electric current of a first inductor connected to a load; detecting an electric current of a second capacitor connected to the load; and calculating a difference current which is the difference between the current detected in the first circuit and the current detected in the second circuit.

The electric current of the first inductor is an electric current flowing in the first inductor and an internal resistor of the first inductor.

In the detecting the electric current of the first inductor, the electric current of the first inductor is detected through an RC circuit where a first resistor and a first capacitor which are connected to each other in series are connected to the first inductor in parallel, and both ends of the first capacitor are connected to a first differential amplifier to detect the electric current of the first inductor.

A voltage between both ends of the first capacitor is calculated using V_{C1}(S)=Rₑₛᵣ₁I_{L1}(S), where Rₑₛᵣ₁ is the internal resistor of the first inductor and I_{L1} is the electric current of the first inductor.

The electric current of the second capacitor is an electric current flowing in the second capacitor and an internal resistor of the second capacitor.

In the detecting the electric current of the second capacitor, the electric current of the second capacitor is detected through an inductor-resistor (LR) circuit where a second resistor and a second inductor which are connected to each other in series are connected to the second capacitor in parallel, and both ends of the second inductor are connected to a second differential amplifier to detect the electric current of the second capacitor.

A voltage between both ends of the second inductor is calculated using V_{L2}(S)=Rₑₛᵣ₂I_{C2} where Rₑₛᵣ₂ is the internal resistor of the second capacitor and I_{C2} is the electric current of the second capacitor.

The method further includes outputting a current error signal based on the difference current and a reference current; outputting a compensation signal to compensate the current flowing in the load as much as the current error signal; and controlling the current flowing in the load according to the compensation signal.

The current is controlled by driving a first MOSFET which is connected in series to the load and the first inductor, and a second MOSFET which is connected in parallel to the first MOSFET according to the compensation signal.

### BRIEF DESCRIPTION OF THE DRAWINGS

These and/or other aspects of the invention will become apparent and more readily appreciated from the following description of the exemplary embodiments, taken in conjunction with the accompanying drawings of which:

FIG. 1 is a schematic circuit diagram illustrating the structure of a related art switching type current-controlled converter;

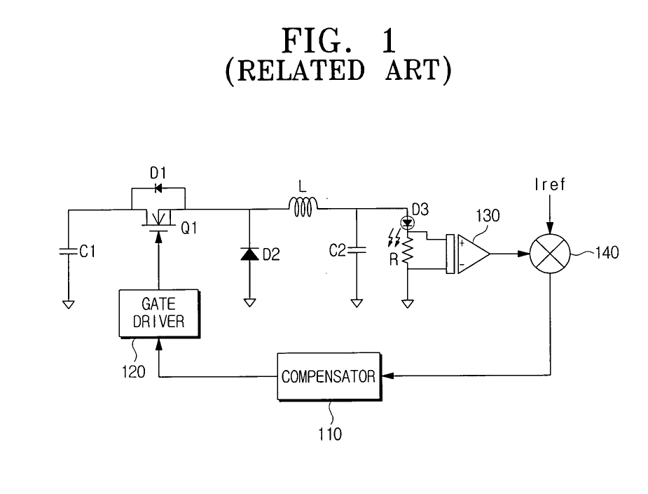

FIG. 2 is a schematic circuit diagram illustrating the structure of a current detecting circuit according to an exemplary embodiment of the present invention; and

FIG. 3 is a flow chart illustrating a current detecting method according to an exemplary embodiment of the present invention.

### DETAILED DESCRIPTION OF EXEMPLARY EMBODIMENTS OF THE PRESENT INVENTION

Reference will now be made in detail to the present exemplary embodiments of the present invention, examples of which are illustrated in the accompanying drawings, wherein like reference numerals refer to like elements throughout. The exemplary embodiments are described below in order to explain the present invention by referring to the figures.

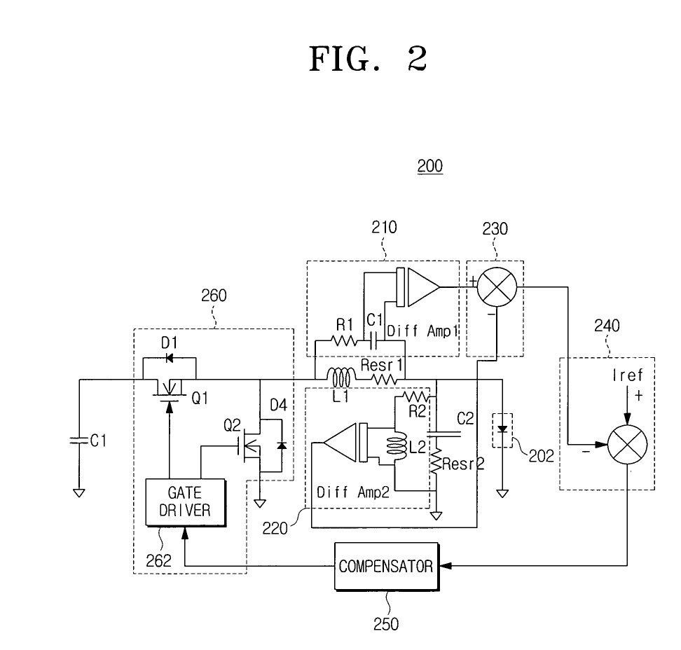

FIG. 2 is a schematic circuit diagram illustrating the structure of a current detecting circuit according to an exemplary embodiment of the present invention.

The current detecting circuit 200 according to an exemplary embodiment of the present invention comprises an RC circuit 210 which detects the current in a first inductor L1 connected to a load 202 in series, an LC circuit 220 which detects the current in a second capacitor C2 connected to the load 202 in parallel, and a subtractor 230 which calculates the difference between the current detected from the RC circuit 210 and the current detected from the LC circuit 220.

Additionally, the current detecting circuit 200 further comprises a current error detector 240 which outputs a current error signal in case of a discrepancy in current (error) between the difference current output from the subtractor 230 and a reference current Iref, a compensator 250 which outputs a compensation signal to compensate the current flowing in the load 202 at the level of the current error output from the current error detector 240, and a switching part 260 which controls the current flowing in the load 202 according to the compensation signal output from the compensator 250.

In the switching part 260, a first MOSFET Q1 is connected in series to the load 202 and the first inductor L1, and a second MOSFET Q2, which is grounded, is connected in parallel to the first MOSFET Q1. The switching part 260 further comprises a gate driver 262 which drives the first MOSFET Q1 and the second MOSFET Q2 according to the transmitted compensation signal.

The first MOSFET Q1 and the second MOSFET Q2 are switching elements each embedded with a body diode (D1 and D4 respectively) which is connected inversely in parallel.

The current of the first inductor L1 refers to the current flowing through the first inductor L1 and an internal resistor Rₑₛᵣ₁ of the first inductor L1.

In the RC circuit 210, the first resistor R1 and the first capacitor C1 which are connected to each other in series are connected to the first inductor L1 in parallel, and a first differential amplifier Diff Amp 1 is connected to both ends of the first capacitor C1 in order to detect the current of the first inductor L1.

The voltage V_{C1} between both ends of the first capacitor C1 can be calculated using Equation 1.

V_{C1}(S)=Rₑₛᵣ₁I_{L1}(S) [Equation 1]

where Rₑₛᵣ₁ is the internal resistor of the first inductor L1, and I_{L1} is the current of the first inductor L1.

The current of the second capacitor C2 refers to the current flowing through the second capacitor C2 and an internal resistor Rₑₛᵣ₂ of the second capacitor C2.

In the LR circuit 220, the second resistor R2 and the second inductor L2 which are connected to each other in series are connected to the second capacitor C2 in parallel, and a second differential amplifier Diff Amp 2 is connected to both ends of the second inductor L2 in order to detect the current of the second capacitor C2.

The voltage V_{L2} between both ends of the second inductor L2 can be calculated using Equation 2.

V_{C2}(S)=Rₑₛᵣ₂I_{C2} [Equation 2]

where Rₑₛᵣ₂ is the internal resistor of the second capacitor C2, and I_{C2} is the current of the second capacitor C2.

The operation of a current detecting circuit according to an exemplary embodiment of the present invention will now be described.

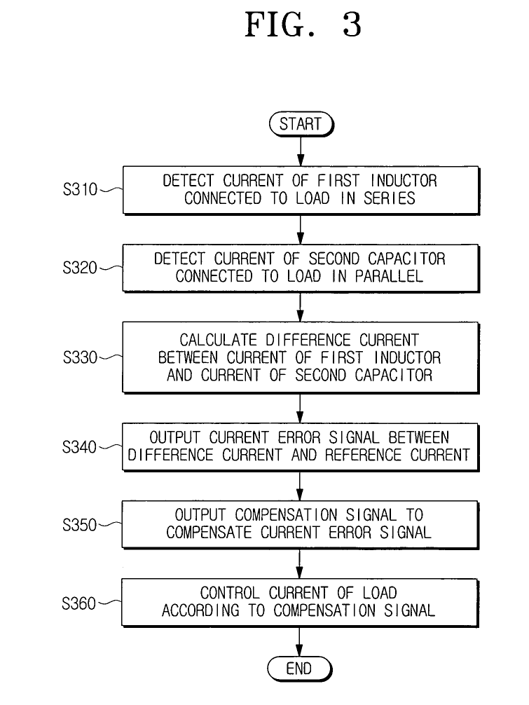

FIG. 3 is a flow chart illustrating a current detecting method according to an exemplary embodiment of the present invention.

A current source converter according to an exemplary embodiment of the present invention uses a synchronous buck converter and comprises an RC circuit 210 at one end and an LC circuit 220 at the other end of an LC filter of a buck converter in order to detect the load current.

The current flowing in the load 202 is measured by subtracting the ripple current of an output of the second capacitor C2 from the current flowing in the first inductor L1 of the buck converter.

For this, the current of the first inductor L1 connected to the load 202 in series is detected (S310).

That is, the inductor current of the buck converter is detected using the voltage of the first capacitor C1 of the RC circuit 210. The function operating between the current of the first inductor L1 and the voltage of the first capacitor C1 of the RC circuit 210 can be expressed as in Equation 3 below.

$$\frac{{V}_{C 1} ( S )}{{I}_{L 1} ( S )} = {R}_{esr 1} [ \frac{S / ( {R}_{esr 1} / L 1 ) + 1}{S / ( 1 / R 1 C 1 ) + 1} ] \qquad [ Equation 3 ]$$

The voltage of the first capacitor C1 causes effects such as resistor current sensing according to the condition of Equation 4 below, so the voltage of the first capacitor C1 is indirectly detected by the voltage of the first inductor L1 as in Equation 1.

$$\frac{1}{R 1 C 1} = \frac{{R}_{esr 1}}{L 1} \qquad [ Equation 4 ]$$

The ripple current of the output capacitor is detected using the voltage of the inductor L2 of the LR circuit 220, and the current flowing in the load 202 is calculated using the subtractor 230. In order to compensate for the difference in current detected in the load current which is close to the reference current Iref, the compensator 250 drives the MOSFET using the gate driver 262.

For this, the current of the second capacitor C2 connected to the load 202 in parallel is detected (S320).

That is, the current of the second capacitor C2 is detected using the voltage of the second inductor L2 of the LR circuit 220 connected to the second capacitor C2, and the function between the current of the second capacitor C2 and the voltage of the second inductor L2 can be expressed as in Equation 5 below.

$$\frac{{V}_{L 2} ( S )}{{I}_{C 2} ( S )} = {R}_{esr 2} [ \frac{S + 1 / ( {R}_{esr 2} C 2 )}{S + ( R 2 / L 2 )} ] \qquad [ Equation 5 ]$$

The voltage of the second inductor L2 of the LR circuit 220 of Equation 5 indicates the ripple current of the second capacitor C2 according to the following condition.

In Equation 5, which shows the function between the current of the second capacitor C2 and the voltage of the second inductor L2, if the condition in Equation 6 is satisfied, the current of the second capacitor C2 can be detected according to resistor current sensing as in Equation 2.

$$\frac{1}{{R}_{esr 2} C 2} = \frac{R 2}{L 2} \qquad [ Equation 6 ]$$

As such, the difference current which is the difference between the current of the RC circuit 210 and the current of the LR circuit 220 detected according to the above process is calculated (S330).

That is, the scaled difference current flowing in the load 202 is calculated by subtracting the detected current of the LR circuit 220 calculated using Equation 2 from the detected current of the RC circuit 210 calculated using Equation 1.

Subsequently, the current error detector 240 outputs a current error signal using the detected load current signal and the reference current signal Iref (S340).

The current error signal output from the current error detector 240 is transmitted to the compensator 250 such as a current controller, to perform pulse-width modulation (PWM) operation. The compensator 250 generates a compensation signal to compensate the current flowing in the load 202 at the level of the current error based on the transmitted current error and outputs a compensation signal to adjust the duty of the switching part 260 (S350).

In the switching part 260, the gate driver 262 drives the first MOSFET Q1 and the second MOSFET Q2 according to the compensation signal transmitted from the compensator 250 and consequently the current flows according to the compensation signal. Accordingly, the switching part 260 controls the current flowing in the load 202 according to the compensation signal (S360).

The present invention reduces the damage to the overall circuit compared to a related art method of detecting current using a resistor when detecting the load current of the current source with a high current. The present invention also reduces the amount of heat generated compared to such related art method. Additionally, the present invention enhances the overall efficiency of the current source device and decreases manufacturing costs.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A device for detecting an electric current, the device comprising:
a first circuit which detects an electric current of a first inductor connected to a load;
a second circuit which detects an electric current of a second capacitor connected to the load; and
a subtractor which calculates a difference current which is a difference in current between the electric current detected in the first circuit and the electric current detected in the second circuit.

2. The device of claim 1, wherein the electric current of the capacitor is an electric current flowing in the second capacitor and an internal resistor of the capacitor.

3. The device of claim 1, wherein in the second circuit, a second resistor and a second inductor are connected to each other in series, the second resistor and the second inductor are connected to the capacitor in parallel, and both ends of the second inductor are connected to a second differential amplifier to detect the electric current of the second capacitor.

4. The device of claim 3, wherein a voltage between both ends of the second inductor is calculated using V_{L2}(S)=Rₑₛᵣ₂I_{C2} where Resr2 is the internal resistor of the second capacitor and I_{C2} is the electric current of the second capacitor.

5. The device of claim 1, further comprising:
a current error detector which generates an error signal based on the difference current calculated by the subtractor and a reference current;
a compensator which outputs a compensation signal to compensate the current flowing at a level of an error output from the current error detector; and
a switching part which controls the current flowing in the load according to the compensation signal output from the compensator.

6. The device of claim 5, wherein the current error detector generates an error signal if there is a discrepancy in current between the difference current and the reference current.

7. The device of claim 6, wherein the level of the error output from the current error detector indicates the discrepancy in current between the difference current and the reference current.

8. A method for detecting an electric current, comprising:
detecting an electric current of a first inductor connected to a load;
detecting an electric current of a second capacitor connected to the load; and
calculating a difference current which is a difference in current between the electric current detected in the first circuit and the electric current detected in the second circuit.

9. The method of claim 8, wherein the electric current of the second capacitor is an electric current flowing in the second capacitor and an internal resistor of the second capacitor.

10. The method of claim 8, wherein in the detecting the electric current of the second capacitor, the electric current of the second capacitor is detected through an inductor-resistor (LR) circuit where a second resistor and a second inductor are connected to each other in series, the second resistor and the second inductor are connected to the second capacitor in parallel, and both ends of the second inductor are connected to a second differential amplifier to detect the electric current of the second capacitor.

11. The method of claim 10, wherein a voltage between both ends of the second inductor is calculated using V_{L2}(S)=Rₑₛᵣ₂I_{C2} where Resr2 is the internal resistor of the second capacitor and I_{C2} is the electric current of the second capacitor.

12. The method of claim 8, further comprising:
outputting a current error signal based on the difference current and a reference current;
outputting a compensation signal to compensate the current flowing in the load at a level of an error indicated in the current error signal; and
controlling the current flowing in the load according to the compensation signal.

13. The method of claim 12, wherein the current error detector signal is output if there is a discrepancy in current between the difference current and the reference current.

14. The method of claim 13, wherein the level of the error indicated in the current error signal represents the discrepancy in current between the difference current and the reference current.
